(19) United States
(12) Patent Application Publication
(10) Pub. No.: US 2026/0051672 A1
(43) Pub. Date: Feb. 19, 2026

(54) CONDUCTOR CONNECTION TERMINAL

(71) Applicant: WAGO Verwaltungsgesellschaft mbH, Minden (DE)

(72) Inventors: Sergej ISAAK, Stedesdorf (DE); Michael MEYER, Wiedensahl (DE)

(73) Assignee: WAGO Verwaltungsgesellschaft mbH, Minden (DE)

(21) Appl. No.: 19/297,211

(22) Filed: Aug. 12, 2025

(30) Foreign Application Priority Data
Aug. 19, 2024 (DE) 20 2024 104 662.5

(51) Int. Cl. H01R 4/48

(52) U.S. Cl. CPC H01R 4/4811; H01R 4/4819

(57) ABSTRACT

A conductor connection terminal with an insulation material housing having at least one conductor insertion opening for receiving an electrical conductor in a conductor insertion direction is described. At least one spring-loaded clamping connection for connecting an electrical conductor via elastic force is situated in the insulation material housing. The spring-loaded clamping connection has at least one busbar and a clamping spring with a clamping leg having a clamping edge for clamping the electrical conductor to a clamping point on a contact section of the busbar. The spring-loaded clamping connection, as a further component that is separate from the clamping spring and the busbar, has a connecting body via which the clamping spring is fixed to the busbar.

This nonprovisional application claims priority under 35 U.S.C. § 119 (a) to German Patent Application No. 20 2024 104 662.5, which was filed in Germany on Aug. 19, 2024, and which is herein incorporated by reference.

### BACKGROUND OF THE INVENTION

### Field of the Invention

The invention relates to a conductor connection terminal with an insulation material housing having at least one conductor insertion opening for receiving an electrical conductor in a conductor insertion direction, at least one spring-loaded clamping connection for connecting an electrical conductor via elastic force being situated in the insulation material housing, the spring-loaded clamping connection having at least one busbar and a clamping spring with a clamping leg having a clamping edge for clamping the electrical conductor to a clamping point on a contact section of the busbar, and the spring-loaded clamping connection, as a further component that is separate from the clamping spring and the busbar, having a connecting body via which the clamping spring is fixed to the busbar.

### Description of the Background Art

A conductor connection terminal is known from EP 2 956 993 B1, which corresponds to US 2015/0372402, which is incorporated herein by reference.

### SUMMARY OF THE INVENTION

It is thereof an object of the present invention to provide a further improved conductor connection terminal.

This object is achieved with a conductor connection terminal, in that the conductor connection terminal has at least one retaining element that is configured to hold the clamping leg in an open position, the retaining element being formed in one piece with the connecting body or in one piece with the clamping spring, in particular with the contact leg of the clamping spring. The conductor connection terminal may thus be augmented to include an automatic conductor connection function. It is thus possible to connect an electrical conductor to the spring-loaded clamping connection without previously opening the clamping point, since the clamping leg may already be held at the retaining element. In addition, releasing the electrical conductor without a tool is possible. Despite the mentioned additional functions, the conductor connection terminal may be implemented with a relatively small installation space, in particular without, or at least without significant, enlargement compared to known conductor connection terminals. Due to the retaining element being formed in one piece with the connecting body or with the clamping spring, manufacture and installation are simplified, since only relatively few individual parts are present.

The clamping spring may have a contact leg which is used to hold and support the clamping spring, and which supports the clamping spring against the clamping force applied by the clamping leg. The contact leg may be connected to the clamping leg via a spring bend.

The retaining element may be formed in one piece with the connecting body or with the clamping spring. The retaining element can be formed in one piece with the contact leg. In this way, in a manner of speaking the retaining element may be formed as an extension of the contact leg and may extend into an area behind the clamping point, viewed in the conductor insertion direction.

By use of the connecting body, the clamping spring may be held, for example, at a contact leg of the clamping spring. By use of the connecting body, the clamping spring may be held at the busbar, against the clamping force generated by the clamping leg.

The geometries of the clamping spring and/or of the busbar may be simplified by means of such a further component in the form of the connecting body, which is present in addition to the clamping spring and the busbar. Also with a relatively simple geometry of the clamping spring and/or busbar, additional functionalities may be integrated into the conductor connection terminal, such as the mentioned automatic release function of the clamping leg which is held in the open position. A further advantage is that material may be saved at the clamping spring and at the busbar. In particular, the connecting body does not necessarily have to be made of the same material as the clamping spring and/or the busbar, and instead, for example a more economical, more easily processable material or some other material, for example having a lower weight, may be selected. For example, the busbar may be designed without a retaining frame that is formed in one piece with the busbar and that is used to suspend the contact leg of the clamping spring. Such a function may be taken over by the connecting body.

A further advantage is that improved suitability for bulk materials may be made possible for the components, in particular for the clamping spring, which in turn is advantageous for carrying out a tempering process. Better elastic properties of the clamping spring, and at the same time a smaller installation space, may be achieved in this way. In addition, the supplying of the individual parts of the conductor connection terminal during installation may be made easier. The manufacturing process may thus be implemented more reliably and easily.

The connecting body may in particular be configured to transmit solely tensile forces or tensile stresses into the connecting arms. Therefore, the connecting arms do not have to have a particularly rigid design.

The connecting body can have a frame-like design with at least two spaced-apart connecting arms, each extending from a contact leg of the clamping spring toward the busbar. In this way, the connecting body may be provided in a relatively filigreed manner with low material outlay. The space requirements for the connecting body are also thus relatively low. An open space may be provided between the connecting arms. The connecting arms may be coupled to the busbar via a form-fit connection, for example. On the other side, the connecting arms may be coupled to the contact leg via a form-fit connection.

A conductor leadthrough opening through which the electrical conductor to be connected is insertable can be formed between the connecting arms. In this way, the connecting arms surround the conductor leadthrough opening and the inserted electrical conductor. The connecting body may thus be situated in the insulation material housing in a particularly space-saving manner.

The connecting body may be formed, for example, only by the two spaced-apart connecting arms. These connecting arms, in each case as separate components, are then to be connected to the contact leg and the busbar.

The connecting body can have at least one first transverse web via which the connecting arms, at their area facing the contact leg or at their area facing the busbar, are connected to one another. The connecting body is additionally mechanically stabilized in this way. Furthermore, the first transverse web may be used as a suspension option for the contact leg or a portion of the busbar, for example a contact section of the busbar that is guided through the conductor leadthrough opening.

The connecting body can have a second transverse web that is spaced apart from the first transverse web and connects the connecting arms to one another. The connecting body is made even more robust in this way. Then, for example, the contact leg may be suspended on the first transverse web, and the contact section of the busbar may be suspended on the second transverse web. The conductor leadthrough opening may be provided between the first and the second transverse web.

For example, the clamping leg may extend through the conductor leadthrough opening in the connecting body.

The connecting body can be made of a material having less spring stiffness than the clamping spring. This allows relatively economical manufacture of the connecting body from an inexpensive material. In addition, due to the different materials used, the individual components such as the clamping spring and the connecting body may be optimized separately with regard to their elastic properties and with regard to an automatic release function.

The connecting body can be made of a sheet metal material having a lower thickness than the metal sheet from which the clamping spring is formed. This is advantageously implementable, for example, for a connecting body that is subjected to load only by tensile forces, since the bending stiffness is then not as important. Material and weight may be saved by using thin sheet metal.

The connecting body can have a receiving contour for accommodating and/or suspending the contact leg, the receiving contour having a centering element for centering the clamping spring in the receiving contour. This simplifies installation of the parts of the conductor connection terminal. In addition, also during subsequent operation of the conductor connection terminal it is ensured that the clamping spring is always optimally situated in the conductor connection terminal, even when vibration loads occur.

The conductor connection terminal can have an actuating element for manually actuating the clamping leg into the open position. This has the advantage that the conductor connection terminal has its own actuating element, and the user does not have to use some other actuating element such as a tool for actuating the clamping leg. The actuating element may be designed as a push button, an actuating slider, or a swivelable actuating lever, for example.

By use of the actuating lever, upon manual actuation the clamping leg may be transferred into the open position, against the elastic force of the clamping spring, so that the electrical conductor may be inserted at any time without much effort. The clamping leg, together with the contact section of the busbar, may form a clamping point for clamping an electrical conductor between the clamping leg and the contact section. In the open position, at least the clamping edge of the clamping leg is swiveled away from the contact section of the busbar. The clamping leg may, for example, be swiveled between an open position in which the electrical conductor is freely movable between the clamping leg and the contact section, and a clamping position in which the clamping leg clamps the electrical conductor to the contact section.

The actuating lever may have at least one spring entrainment element via which, upon actuation of the actuating lever, the actuating force for deflecting the clamping leg into the open position is transmittable to the at least one actuating surface of the clamping leg. The at least one spring entrainment element may be situated next to the clamping leg, for example.

At least one actuating tab can be formed at the clamping leg, and by means of the actuating element, at the actuating tab the clamping leg may be acted on with an actuating force for deflection into the open position, the at least one actuating tab being situated behind the connecting arms in the conductor insertion direction. When the clamping leg extends through the conductor leadthrough opening, the clamping leg may be widened on both sides, for example on the side of the connecting arms facing away from the spring bend, to form laterally protruding actuating tabs, the actuating tabs adjoining the connecting arms. By use of the actuating tab, the actuating element may reliably actuate the clamping leg, and the actuating element with its spring entrainment element can transmit the actuating force to the actuating tab. In this way, the clamping leg may be easily actuated with a small actuating force.

The insulation material housing can extend in a vertical direction from a housing top side to a housing bottom side. The actuating element may be an actuating lever that is swivelable about a rotational axis, on the housing top side the actuating lever having an actuating section that is manually actuatable by the user.

The rotational axis of the actuating lever may be situated behind the clamping point in the conductor insertion direction; i.e., the rotational axis of the actuating lever may be situated relatively far back in the insulation material housing, viewed in the conductor insertion direction. The necessary actuating forces for actuating the clamping spring may be minimized in this way. For example, the rotational axis may be situated next to a rear housing wall of the insulation material housing.

The rotational axis of the actuating lever may be situated below the clamping point in the vertical direction, with the rotational axis thus situated relatively far below in the insulation material housing, for example at a lower housing wall of the insulation material housing. The actuating lever may thus be integrated into the conductor connection terminal in a particularly space-saving manner. The actuating lever may be supported on the insulation material housing, for example, on the housing bottom side, for example.

At least one retaining tab can be formed on the retaining element, and at its free end the retaining tab extends, opposite the conductor insertion direction, toward the free end of the clamping leg, so that in the open position the clamping leg is fixable to the retaining tab. The retaining element may have a detent element which in the open position is spring-loaded by the clamping leg. Such a design, in particular with a connecting body or clamping spring that is formed in one piece with the retaining element, allows the integration of an automatic conductor connection function in spring-loaded clamping connections and conductor connection terminals having a variety of designs. In particular, well-established conductor connection terminals having known designs may thus be further developed with little complexity for an automatic conductor connection function, i.e., with an automatic conductor connection of the electrical conductor to be clamped. An automatic conductor connection function may advantageously be integrated into present designs of conductor connection terminals in a simple and space-saving manner. No additional holding part is necessary for the retaining function, which simplifies installation of the conductor connection terminal.

The retaining element may be situated so that it is movable, for example displaceable, swivelable, or deflectable in some other way, so that it may be easily deflected by the inserted conductor in order to bring about the desired release effect of the clamping leg from the retaining element. The retaining element may, for example, be displaceably supported, for example displaceable in a linear direction or an arced direction. The retaining element may be swivelably supported. In this case, the retaining element may be swiveled about a fixed or variable swivel axis. In the case of a variable swivel axis, the retaining element may be swivelably supported in a floating manner, for example. The retaining element may also undergo a combined displacement and swivel movement. The retaining element may also be movably supported in some other way so that it is deflectable far enough to release the latch of the clamping leg on the retaining element.

By means of the actuating lever, upon manual actuation against the elastic force of the clamping spring the clamping leg may be transferred into the open position. In this open position, the clamping leg may then be held by the retaining element, in particular also without further manual actuation of the actuating lever, so that at any time it is possible to insert the electrical conductor without much effort. For example, the clamping leg may be latched to the retaining element in the open position.

The clamping leg can have a first detent element, and the at least at least one retaining tab can have a second detent element that is latchable to the first detent element in the open position. This allows simple and reliable mechanical coupling of the clamping leg to the retaining element in the open position, which is also easily releasable. Depending on the example, the first detent element may be formed by an element that is present or by a section of the clamping leg, so that the clamping leg does not have to be modified. For example, the first detent element may be directly formed by the clamping edge.

The conductor connection terminal can have a release element with a release section, and as a result of actuating the release section the retaining element is deflected to the extent that the clamping leg that is held on the retaining element releases from the retaining element. For example, the clamping leg which in the open position is held on the retaining element is releasable from the retaining element when an electrical conductor to be clamped exerts an actuating force on the release section of the release element. This allows the clamping leg to be automatically released from the retaining element by insertion of the electrical conductor. The release section may be acted on with pressure force by a separate tool, a component of the conductor connection terminal, such as an actuating element, or directly via the inserted electrical conductor itself, thus bringing about the release of the clamping leg from the retaining element. By means of the release element, the clamping leg, which in the open position is held on the retaining element, is releasable from the retaining element by the action of pressure on the release section in the conductor insertion direction (L) of the electrical conductor to be connected. Depending on the construction of the conductor connection terminal, the release element may be designed as a separate component.

The release element can be an integral part of the component or of the spring-loaded clamping connection assembly which includes the retaining element. The design and installation effort for the spring-loaded clamping connection may thus be kept low. In particular, for installing the release element and the retaining element it is not necessary to install two different components or assemblies, but, rather, only one. For example, the release element may be formed in one piece with the retaining element. For example, the release element may be situated in the further extension of the contact leg behind the retaining element, in each case viewed in the conductor insertion direction.

The retaining element can be situated in the spring-loaded clamping connection, behind the clamping point or behind the main part of the busbar, in the conductor insertion direction of the electrical conductor. Thus, the retaining element does not hinder insertion of the electrical conductor. For example, in the open position, i.e., when the clamping leg is latched to the retaining element, there may be little or no protrusion of the retaining element with respect to the clamping leg into a conductor receiving space, viewed in the conductor insertion direction.

The actuating lever can have a U-shaped design viewed in the conductor insertion direction, an electrical conductor being insertable into the interior of the U shape. This allows a particularly compact design of the conductor connection terminal, so that the actuating lever can transmit large forces, but has only negligible additional space requirements. This is due in particular to the fact that the interior of the U shape may be utilized for placing the electrical conductor to be clamped.

For example, the actuating lever may have a manual actuating section, for example in the form of a lever handle, from which the actuating lever extends around the arrangement of the clamping spring and/or busbar via two side flanks that protrude, for example in parallel, from the manual actuating section. If the spring-loaded clamping connection is situated in an insulation material housing of a conductor connection terminal, the side flanks may be situated inside the insulation material housing. A spring entrainment element, which may be formed in one piece on the particular side flank, for example, may be situated at each of the side flanks. By means of such a spring entrainment element, the clamping spring may be actuated either directly at the clamping leg, or at respective actuation sections that are associated with the spring entrainment elements and that protrude laterally beyond the clamping leg, and are accordingly swiveled into the open position.

A conductor receiving space for accommodating the electrical conductor to be clamped to the contact section may be provided in the insulation material housing, the release section of the release element being situated in the conductor receiving space or at least protruding into the conductor receiving space.

The release section of the release element may be situated behind the contact section or at least behind the clamping point in the conductor insertion direction.

A test contact that is used for electrical testing via a rear test opening in the insulation material housing may be formed in one piece on the retaining element.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal in a perspective view,

FIG. 2 shows the conductor connection terminal according to FIG. 1 in a side sectional view in the clamping position,

FIG. 3 shows the conductor connection terminal according to FIG. 2 in the open position,

FIG. 4 shows the conductor connection terminal according to FIG. 2 with an inserted electrical conductor,

FIG. 5 shows a clamping spring in a side view,

FIG. 6 shows the clamping spring according to FIG. 5 in a perspective view,

FIG. 7 shows a connecting body in a side view,

FIG. 8 shows the connecting body according to FIG. 7 in a perspective view,

FIG. 9 shows a spring-loaded clamping connection in a side view,

FIG. 10 shows the spring-loaded clamping connection according to FIG. 9 in a perspective view,

FIG. 11 shows an actuating lever in a perspective view,

FIG. 12 shows a busbar in a perspective view,

FIG. 13 shows an example of a clamping spring in a side view,

FIG. 14 shows the clamping spring according to FIG. 13 in the latched open position,

FIG. 15 shows the clamping spring according to FIG. 13 in a perspective view,

FIG. 16 shows an example of a connecting body in a side view,

FIG. 17 shows the connecting body according to FIG. 16 in a perspective view, and

FIG. 18 shows a spring-loaded clamping connection in a perspective view.

### DETAILED DESCRIPTION

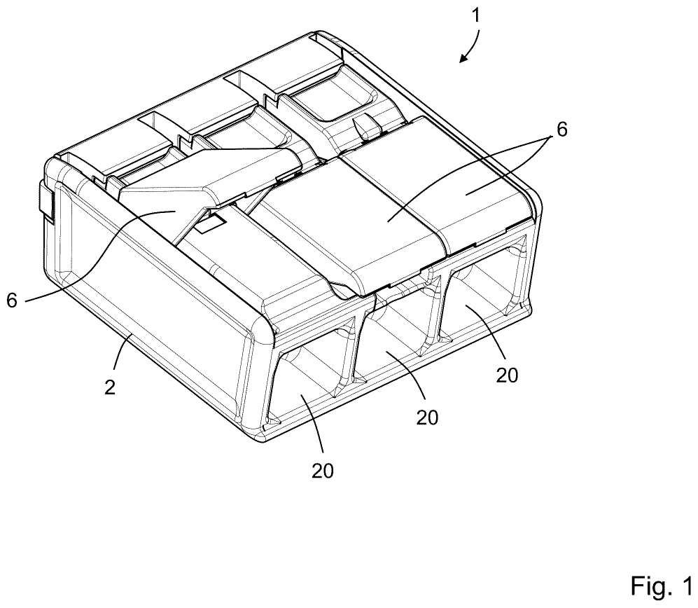

FIG. 1 shows a conductor connection terminal 1 with an insulation material housing 2. In the illustrated example, the conductor connection terminal 1 is designed as a multipole conductor connection terminal. Accordingly, the conductor connection terminal 1 has multiple conductor insertion openings 20 in the insulation material housing 2 through which an electrical conductor to be clamped may be inserted in each case. Multiple spring-loaded clamping connections are situated in the insulation material housing 2, each spring-loaded clamping connection being associated with a conductor insertion opening 20. The conductor connection terminal 1 in each case has a swivelable actuating lever 6 for actuating the clamping spring of each spring-loaded clamping connection.

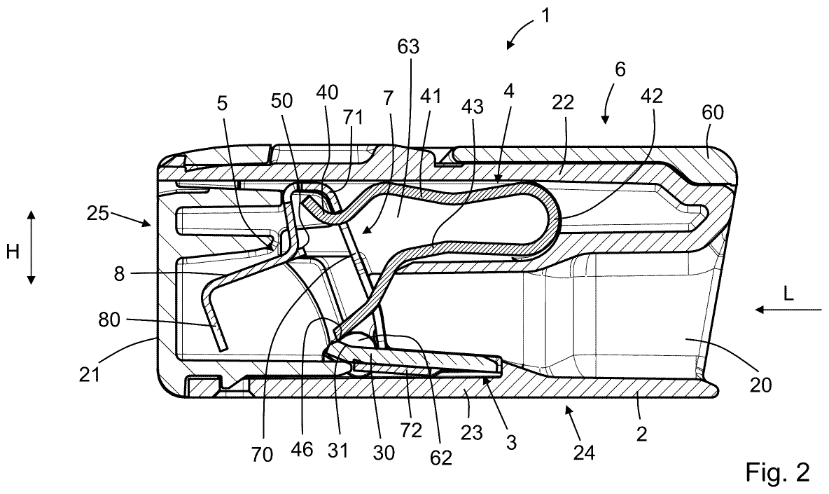

FIG. 2 shows a side sectional view of the conductor connection terminal 1 according to FIG. 1 in a section plane that passes centrally through a spring-loaded clamping connection. The insulation material housing 2 extends in a vertical direction H from a housing top side 22 that may be formed by an upper housing wall, to a housing bottom side 23 that may be formed by a lower housing wall. At a conductor insertion side the insulation material housing 2 has the conductor insertion opening 20, which is used for insertion of an electrical conductor in a conductor insertion direction L. The insulation material housing 2 has a rear housing wall 21 on the end facing away from the conductor insertion side. In this example, the rear housing wall 21 is designed as part of a rear housing cover 25 which may close an opening in a main housing part 24.

It is apparent that the spring-loaded clamping connection situated in the insulation material housing 2 has a clamping spring 4 and a busbar 3. The busbar 3 has a contact section 30. The contact section 30 is used for electrical contacting of a connected electrical conductor. The clamping spring 4 has a contact leg 41 that is fastened to the busbar 3 via a fastening section 40 of the contact leg 41. The fastening section 40 may be designed as part of the contact leg 41. The clamping spring 4 has a spring bend 42 that adjoins the contact leg 41, and a clamping leg 43 that adjoins the spring bend 42 and is used for clamping an electrical conductor to the contact section 30, in particular to a clamping point 30. At the free end the clamping leg 43 ends with a clamping edge 46.

In the insulation material housing 2 the conductor connection terminal 1 also has a connecting body 7 which fixes the clamping spring 4 to the busbar 3. The connecting body 7 has a first transverse web 71 for fastening the contact leg 41 or its fastening section 40. The contact leg 41 together with the fastening section 40 may be suspended on this first transverse web 71. The connecting body 7 extends from the first transverse web 71 toward the busbar 3 via two spaced-apart connecting arms 70. The connecting arms 70 are connected to one another in the area of the busbar 3 by a second transverse web 72. The busbar 3 with its contact section 30 may be supported on this second transverse web 72 or suspended there. As is apparent, in this installed state the second transverse web 72 is situated on the side of the busbar 3 facing away from the clamping leg 43. The clamping spring 4 is fixed between the first transverse web 71 and the busbar 3, which is held at the second transverse web 72.

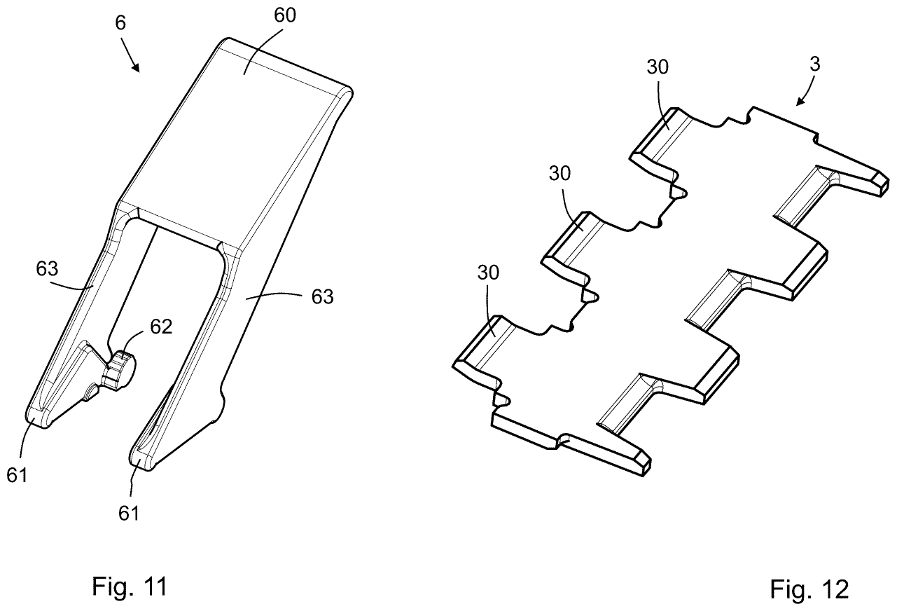

The actuating lever 6, which is illustrated in greater detail in FIG. 11, is provided for actuating the clamping spring 4, i.e., for deflecting the clamping leg 43 from the clamping position illustrated in FIG. 2 into an open position The actuating lever 6 has a manual actuating section 60 that protrudes from the insulation material housing 2. At the manual actuating section 60 the actuating lever 6 may be gripped and swiveled by the user. The actuating lever 6 extends into the insulation material housing 2 via side flanks 63.

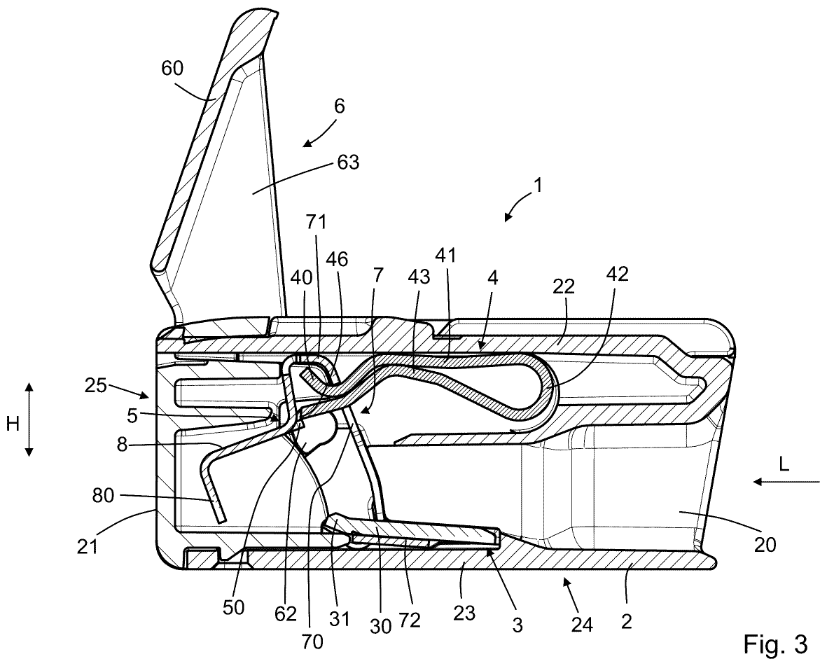

It is apparent in FIG. 11 that the actuating lever 6 extends from the manual actuating section 60, via the respective side flank 63, toward a support area 61 on which the actuating lever 6 is swivelably supported at the housing bottom side 23. The actuating lever 6 is rotatable about a rotational axis, i.e., is movable back and forth between a closed end position, illustrated in FIG. 2, and an open end position illustrated in FIG. 3. It is also apparent in FIG. 11 that at a respective side flank 63 the actuating lever 6 has a spring entrainment element 62 which is in contact with the clamping leg 43 or an actuating tab 47 formed on the clamping leg 43, and which presses the clamping leg 43 into the open position when the actuating lever 6 is swiveled into the open end position.

When the actuating lever 6 is swiveled into the open end position, via the spring entrainment element 62 the clamping leg 43 is swiveled in a direction that continues from the contact section 30, and is transferred into the open position as is apparent in FIG. 3. The clamping point may thus be opened, so that a clamped electrical conductor may be removed or an electrical conductor to be clamped may be easily inserted. In this open position the clamping leg 43 may be latched to a retaining element 5. The retaining element 5 is used to hold the clamping leg 43 in the open position, even when the actuating lever 6 is once again in the closed end position.

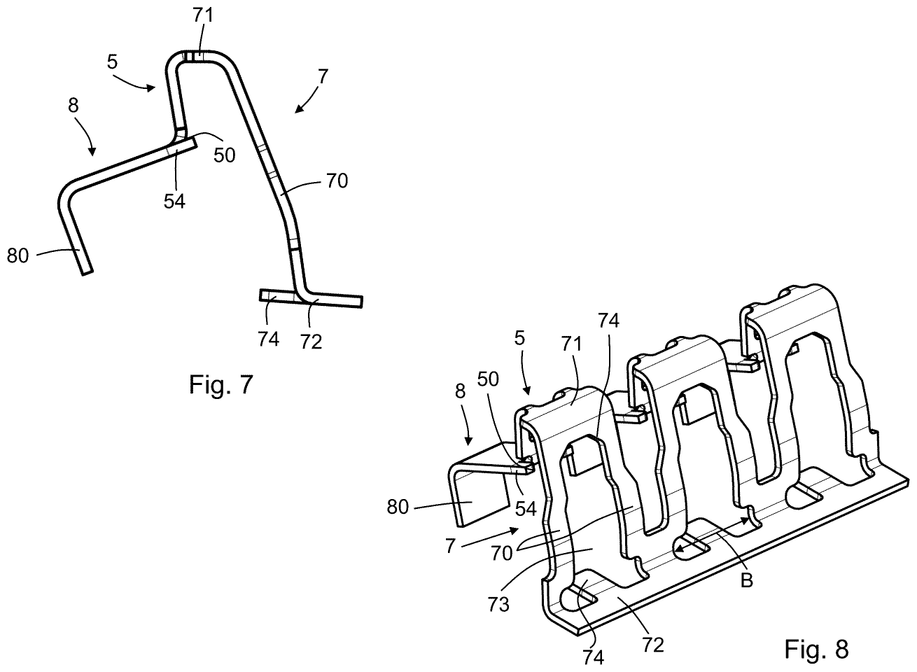

In the example illustrated in FIG. 2, the connecting body 7 is formed in one piece with the retaining element 5, for example by the retaining element 5 adjoining the first transverse web 71. In addition, a release element 8 is formed in one piece with the retaining element 5, for example in such a way that the release element 8 adjoins the retaining element 5 on the side facing away from the first transverse web 71. Accordingly, in the illustrated example, the connecting body 7, the retaining element 5, and the release element 8 may be formed in one piece from a sheet metal part, as is also apparent in FIGS. 7 and 8.

The retaining element 5 has at least one detent arm 54, as is apparent in FIGS. 7 and 8, which may be flared out from the material of the retaining element 5, for example at the side of the retaining element 5, by means of a stamping/bending process, for example. The detent arm 54 has a second detent element 50 in the area of the free end. At the clamping leg 43 a first detent element is formed by the clamping edge 46 or by an additional element.

In FIG. 3 the actuating lever 6 is swiveled into the open end position. Via the spring entrainment element 62 the clamping leg 43 is now moved into the open position, in which the clamping edge 46 latches with the second detent element 50. If the actuating lever 6 is now moved back into the closed end position, the clamping leg 43 remains in the open position since it is held by the retaining element 5.

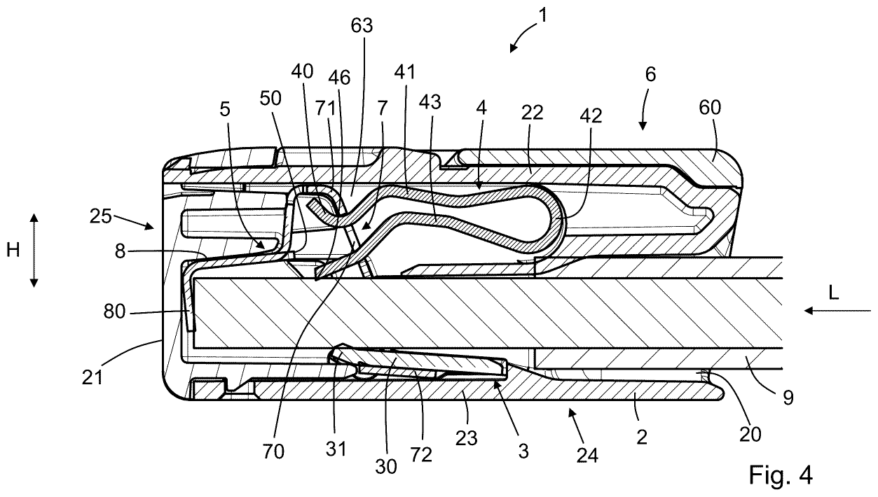

The retaining element 5 further extends in the conductor insertion direction L to the release element 8, which merges into a section which is angled with respect to the retaining element 5 and extends transversely to the conductor insertion direction L, and which forms the release section 80 of the release element 8. If an electrical conductor 9 is inserted through the conductor insertion opening 20 and into the insulation material housing 2 in the conductor insertion direction L, as shown in FIG. 4, pressing the end of the electrical conductor 9 against the release section 80 causes the entire unit made up of the release element 8 and the retaining element 5 to be deflected. As a result, the release section 80 together with the retaining element 5 or at least the second detent element 50 is displaced slightly to the rear in the conductor insertion direction L, so that the clamping leg 43 can release from the second detent element 50. Accordingly, the clamping leg 43 can rebound and press the electrical conductor 9 against the contact section 30. The clamping leg 43 thus moves into the clamping position due to the spring pretensioning of the clamping spring 4.

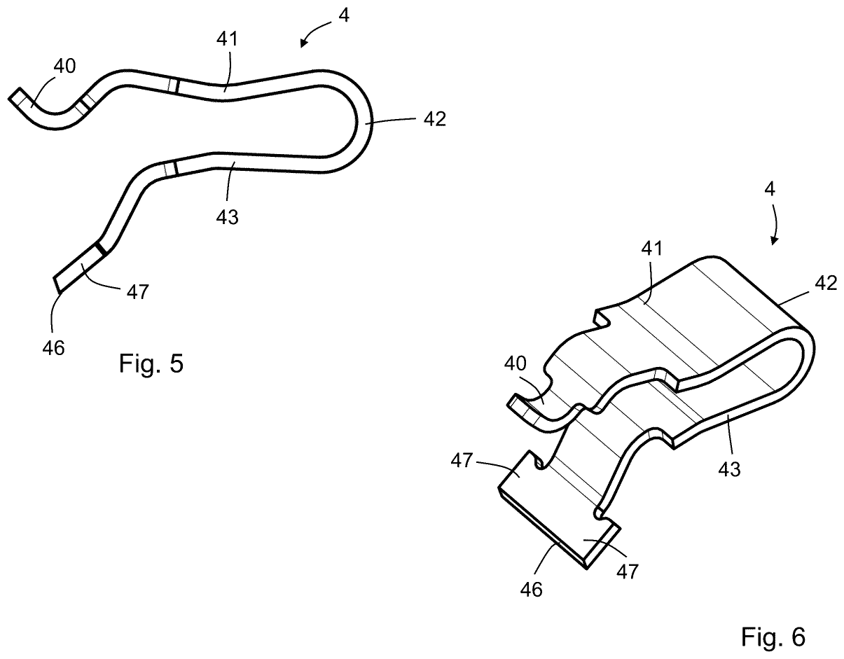

FIGS. 5 and 6 show examples of a clamping spring 4 together with the previously explained elements: fastening section 40, contact leg 41, spring bend 42, and clamping leg 43 with the clamping edge 46. It is apparent in particular that the clamping leg 43 may have actuating tabs 47 that protrude laterally in the area of the free end of the clamping leg, and that project on both sides of the clamping leg 43, the clamping edge 46 extending between the actuating tabs 47. It is also conceivable for the clamping edge 46 to extend in the area of the actuating tabs 47.

FIGS. 7 and 8 illustrate an example of the connecting body 7. The conductor connection terminal 1 may be designed as a multipole conductor connection terminal, for example, in which multiple spring-loaded clamping connections or multiple clamping springs are situated side by side. Accordingly, for each clamping spring 4 the connecting body 7 may in each case have neighboring connecting arms 70, arranged in pairs, which at their end areas are joined together by the first transverse web 71 and the second transverse web 72. A conductor leadthrough opening 73 for guiding the electrical conductor through is formed between these elements 70, 71, 72. As illustrated in FIG. 8, the second transverse webs 72 may be designed as a continuous, one-piece metal section, so that a connecting body 7 that is formed in one piece provides receiving options for multiple, in this case, three, clamping springs 4.

As illustrated in the figures, support tabs 74 extend from the second transverse webs 72 and into the conductor leadthrough opening 73. The support tabs 74 are used as abutment and support for the busbar 3.

It is also apparent that the conductor leadthrough opening 73 is much wider at the area facing the second transverse web 72 and has a width B. This is advantageous for installing the clamping spring 4, so that the clamping leg 73 with the actuating tabs 47 situated thereon may be easily inserted through the conductor leadthrough opening 73. The width B may, for example, be slightly greater than the width of the clamping leg 43 in the area of the actuating tabs 47.

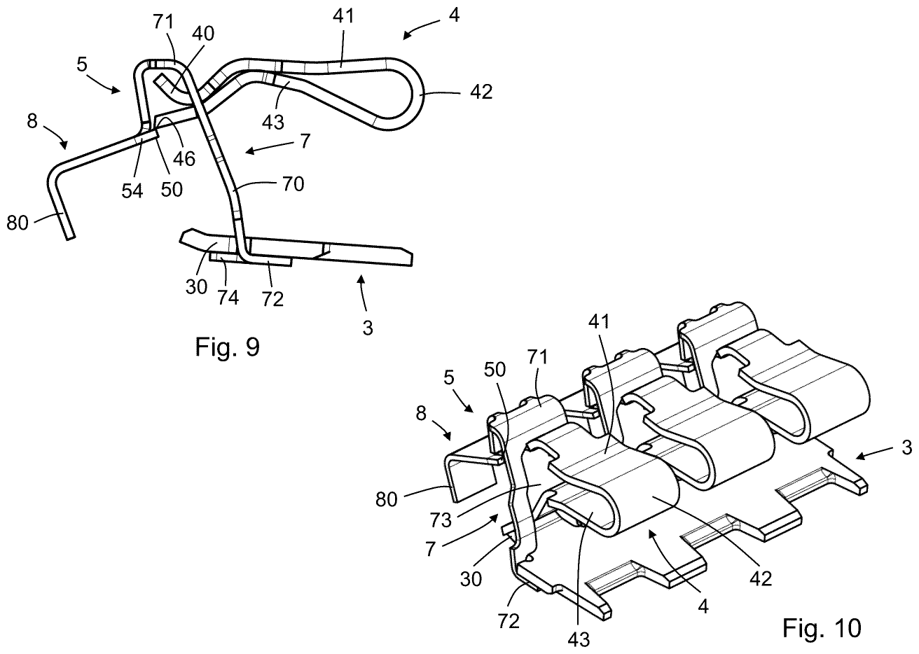

As shown in FIG. 9, in which a busbar 3 of the above-described type is combined with a connecting body 7 according to FIGS. 7 and 8 and a clamping spring 4 according to FIGS. 5 and 6, the clamping spring 4 with its contact leg 41, and in particular the fastening section 40, may be suspended on the first transverse web 71 in the conductor leadthrough opening 73. The busbar with its contact section 30 is suspended on the second transverse web 72 in the conductor leadthrough opening 73. When the clamping leg 43 is moved into the open position, as illustrated in FIG. 9, the clamping leg 43 with its clamping edge 46 or some other detent element latches to the second detent element 50 of the retaining element 5. The clamping leg 43 is thus held in the open position.

FIG. 10 shows the spring-loaded clamping connection, explained with reference to FIG. 9, with the previously explained three neighboring clamping springs 4, which are each illustrated in the clamping position in FIG. 10. It is apparent that the busbar 3 may also be designed as a continuous component in the direction of arrangement of the clamping springs 4, from which a contact section 30 that is associated with a clamping spring 4 protrudes in each case, as also shown in FIG. 12.

FIG. 11 shows an actuating lever 6 with further details. It is apparent that at opposite sides of the manual actuating section 60 the actuating lever 6 has side flanks 63 which in each case protrude essentially at a right angle therefrom. The side flanks 63 extend from the manual actuating section 60, thus forming a U shape. In this area the side flanks 63 are not joined together; i.e., an open space is present there between the side flanks 63. A support area 61 and a spring entrainment element 62 are formed in each case at the side flanks 63. The spring entrainment elements 62 are preferably situated at mutually facing inner sides of the two side flanks 63.

FIG. 12 shows a busbar 3, which in this example is designed as a continuous busbar that extends over multiple spring-loaded clamping connections. The busbar 3 has a respective contact section 31 for each spring-loaded clamping connection. It would also be possible for the busbar 3 to not be designed as a continuous busbar.

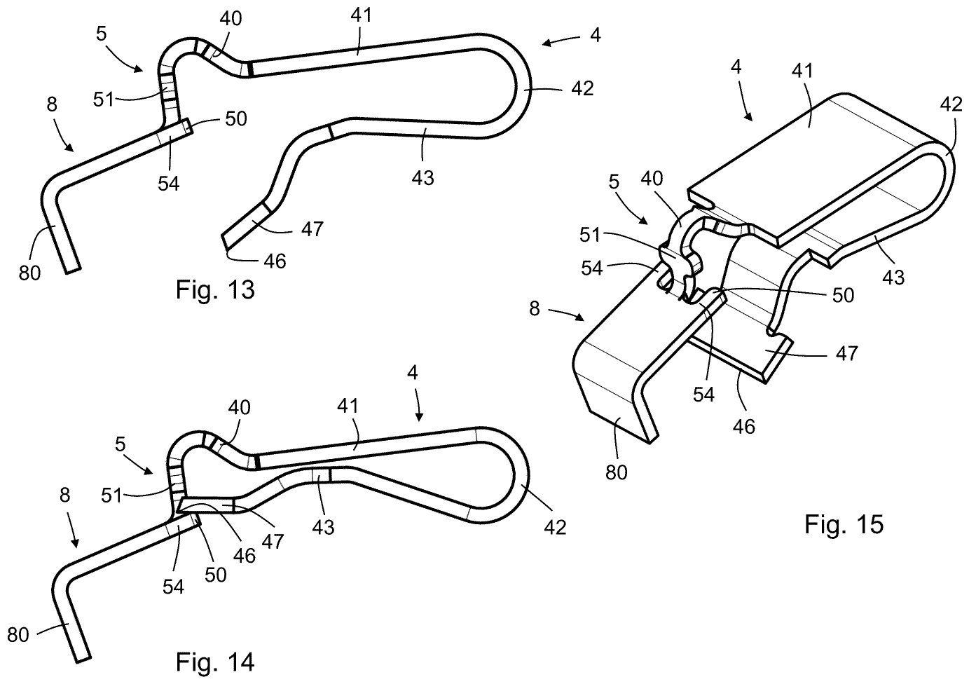

FIGS. 13 through 15 show an example of a clamping spring 4, in which the previously explained retaining element 5 and the release element 8 are formed in one piece with this clamping spring 4. On each side to the left/right of the retaining element 5, a retaining tab 54 may be present on which a second detent element 50 is provided in each case. The retaining tabs 54 extend oppositely from the conductor insertion direction L. Analogously, a latching tab may be formed in each case to the left and right of the clamping leg 43, on which a first detent element is present in each case which is configured to latch with a respective retaining tab 54. However, in the illustrated example, the latching of the retaining tabs 54 takes place directly with the clamping leg 43 in the area of the clamping edge 46. The clamping leg 43 may thus be symmetrically latched to the retaining element 5 on both sides. As is apparent, the retaining element 5 adjoins the fastening section 40 of the contact leg 41. The release element 8 is once again formed in one piece with the retaining element 5, and adjoins this retaining element 5 on the side facing away from the fastening section 40.

A transversely oriented widening of the web that connects the fastening section 40 to the release element 8 is provided at the retaining element 5. This widening is used as a test contact 51 for a rear test opening in the insulation material housing 2.

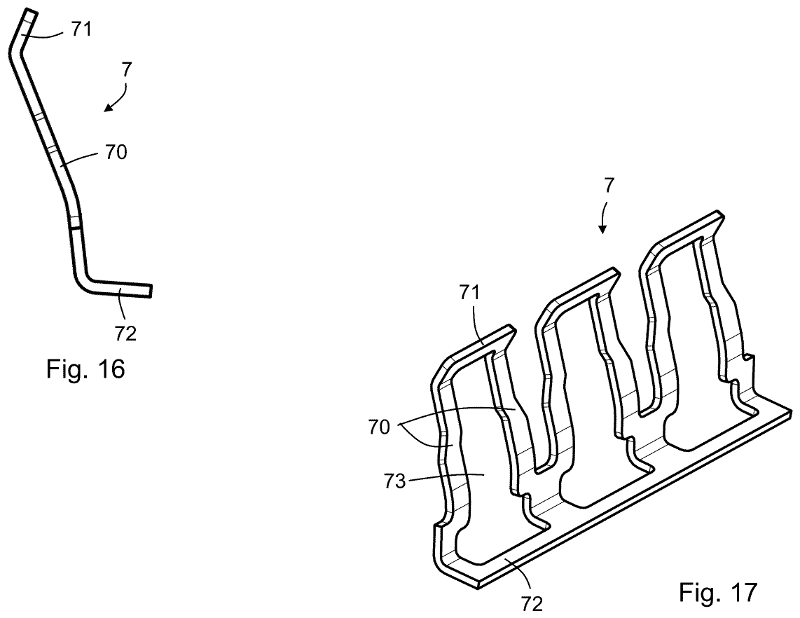

FIGS. 13 and 15 show the clamping spring in the clamping position or in the relaxed state, and FIG. 14 shows the clamping spring in the open position, latched to the detent element 50.

FIGS. 16 and 17 show an example of a connecting body 7, which in comparison to the connecting body explained above has a simpler design and does not have the retaining element 5 and release element 8 formed in one piece. This results in a comparatively simple design in which the connecting body 7 for a clamping spring in each case has only the two spaced-apart connecting arms 70 and the first and second transverse webs 71, 72, which are situated at opposite ends of the connecting arms 70 and join the connecting arms 70 together, with the conductor leadthrough opening 73 once again being situated between the connecting arms 70 and the transverse webs 71, 72. Also in this example, the second transverse webs 72 may be designed as a continuous metal part.

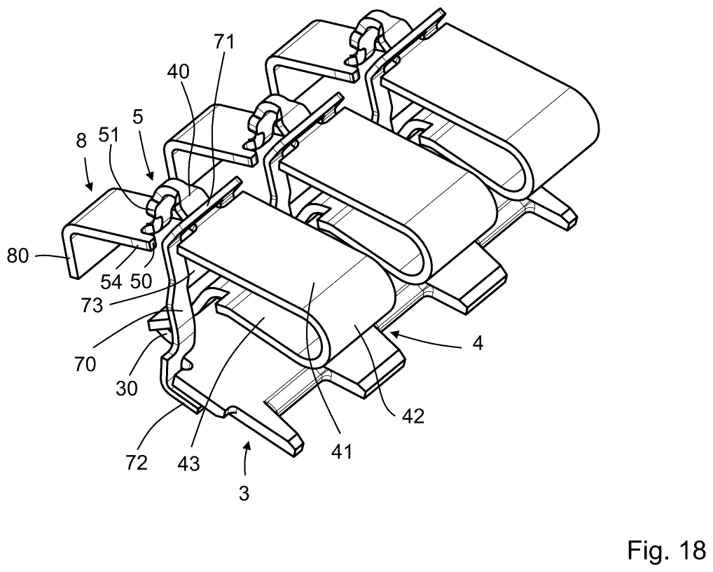

FIG. 18 shows a spring-loaded clamping connection in which multiple clamping springs 4 of the type explained with reference to FIGS. 13 through 15 are connected to a busbar 3 via a connecting body 7 of the type explained with reference to FIGS. 16 and 17. The busbar 3 may be designed according to FIG. 12, for example. Once again a contact section 30 of the busbar 3 extends in each case through a conductor leadthrough opening 73 that is associated with a respective clamping spring 4 which is suspended in this conductor leadthrough opening 73.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
an insulation material housing having at least one conductor insertion opening to receive an electrical conductor in a conductor insertion direction;
at least one spring-loaded clamping connection to connect an electrical conductor via elastic force is arranged in the insulation material housing, the spring-loaded clamping connection having at least one busbar and a clamping spring with a clamping leg having a clamping edge to clamp the electrical conductor to a clamping point on a contact section of the busbar, the spring-loaded clamping connection, being a further component that is separate from the clamping spring and the busbar, having a connecting body via which the clamping spring is fixed to the busbar; and
at least one retaining element that is configured to hold the clamping leg in an open position, the retaining element being formed in one piece with the connecting body or in one piece with the clamping spring or with the contact leg of the clamping spring.

2. The conductor connection terminal according to claim 1, wherein the connecting body has a frame-like design with at least two spaced-apart connecting arms, each extending from a contact leg of the clamping spring toward the busbar.

3. The conductor connection terminal according to claim 2, wherein a conductor leadthrough opening, through which the electrical conductor to be connected is insertable, is formed between the connecting arms.

4. The conductor connection terminal according to claim 2, wherein the connecting body has at least one first transverse web via which the connecting arms, at their area facing the contact leg or at their area facing the busbar, are connected to one another.

5. The conductor connection terminal according to claim 4, wherein the connecting body has a second transverse web that is spaced apart from the transverse web and connects the connecting arms to one another.

6. The conductor connection terminal according to claim 5, wherein the conductor leadthrough opening is provided between the first and the second transverse web.

7. The conductor connection terminal according to claim 1, wherein the connecting body is made of a material having less spring stiffness than the clamping spring.

8. The conductor connection terminal according to claim 1, wherein the connecting body is made of a sheet metal material having a lower thickness than the metal sheet from which the clamping spring is formed.

9. The conductor connection terminal according to claim 1, wherein the connecting body has a receiving contour for accommodating and/or suspending the contact leg, the receiving contour having a centering element for centering the clamping spring in the receiving contour.

10. The conductor connection terminal according to claim 1, wherein the conductor connection terminal has an actuating element for manually actuating the clamping leg into the open position.

11. The conductor connection terminal according to claim 10, wherein at least one actuating tab is formed at the clamping leg, and via the actuating element, at the actuating tab the clamping leg is adapted to be acted on with an actuating force for deflection into the open position, the at least one actuating tab being arranged behind the connecting arms in the conductor insertion direction.

12. The conductor connection terminal according to claim 1, wherein the conductor connection terminal has a release element with a release section, and as a result of actuating the release section, the retaining element is deflectable to the extent that the clamping leg that is held on the retaining element releases from the retaining element.

13. The conductor connection terminal according to claim 12, wherein the clamping leg which, in the open position, is held on the retaining element and is releasable from the retaining element when an electrical conductor to be clamped exerts an actuating force on the release section of the release element.

14. The conductor connection terminal according to claim 12, wherein the release element is formed in one piece with the retaining element.
